(19) United States
(12) Patent Application Publication
(10) Pub. No.: US 2024/0369399 A1
(43) Pub. Date: Nov. 7, 2024

(54) BALE WEIGHING SYSTEM

(71) Applicant: Marathon Equipment Company, South Vernon, AL (US)

(72) Inventors: Bradley Michael Agoston, Fayette, AL (US); Daniel Robert Overstreet, Caledonia, MS (US); Phillip Kendrick, Chattanooga, TN (US)

(21) Appl. No.: 18/652,623

(22) Filed: May 1, 2024

Related U.S. Application Data
(60) Provisional application No. 63/463,531, filed on May 2, 2023.

(51) Int. Cl. G01G 21/23; B30B 9/30

(52) U.S. Cl. CPC G01G 21/23; B30B 9/3007; B30B 9/3042

(57) ABSTRACT

A bale weighing kit includes a scale, an elongated support channel configured to couple with the scale and support a baler, and an anchor brace configured to couple with the support channel and laterally constrain movement of the support channel with respect to a ground support surface. The anchor brace includes an anchor plate with a surface configured to receive and support a portion of the scale.

### CROSS-REFERENCE TO RELATED APPLICATION

This application claims the benefit under 35 U.S.C. § 119 (e) of U.S. Patent Application No. 63/463,531, entitled “Bale Weighing System,” filed May 2, 2023, which is incorporated herein by reference in its entirety.

### TECHNICAL FIELD

This disclosure generally relates to compactor devices, and more particularly, to vertical balers configured to compress and weigh materials.

### BACKGROUND

Various compactor devices (e.g., balers) for compacting waste materials (e.g., refuse such as cardboard, paperboard, or the like) exist in the art. These compactor devices generally include a housing defining a compaction chamber, a closable door, and a compacting device (e.g., a hydraulically-powered ram) that is actuated to perform a compaction cycle in the compaction chamber. It is often desired to know the weight of a bale of material. Some systems have been proposed for determining the weight of a bale while still in the baler, but further improvements are sought.

### SUMMARY

Among other things, various embodiments of this disclosure include bale weighing systems. In some embodiments, the systems feature weighing kits for balers that include a scale. In some embodiments, the systems feature a baler equipped with a weighing kit that includes a scale.

One aspect of the present disclosure features a weighing kit for a baler, the weighing kit including a scale; an elongated support channel configured to couple with the scale and support a baler; and an anchor brace configured to couple with the elongated support channel and laterally constrain movement of the elongated support channel with respect to a ground support surface, the anchor brace including an anchor plate with a surface configured to receive and support a portion of the scale.

Embodiments may include one or more of the following features.

In some embodiments, the elongated support channel is configured to be removably coupled with a structural feature of a base of the baler.

In some embodiments, the structural feature is a laterally-extending flange of the base of the baler.

In some embodiments, the elongated support channel defines a slot configured to align with a hole defined by a base of the baler.

In some embodiments, the elongated support channel is configured to be coupled with the anchor brace in a parallel direction.

In some embodiments, the anchor brace has a pair of opposing, lateral walls and a capture plate opposing the anchor plate, the anchor plate configured to rest on the ground support surface.

In some embodiments, a lateral wall of the pair of opposing, lateral walls define a notch.

In some embodiments, the anchor plate extends longitudinally under the scale, and a foot of the scale is configured to rest on the anchor plate.

In some embodiments, the anchor plate is configured to be secured to the ground support surface at one or more mounting points.

In some embodiments, the scale includes a shear beam load cell having a first end extending over and secured to the elongated support channel, and a second end supported on a foot resting on the ground support surface.

In some embodiments, the scale further includes a second shear beam load cell extending over and secured to the elongated support channel, the second shear beam load cell including a third end supported on a second foot resting on the ground support surface, wherein the shear beam load cell is a first shear beam load cell, the foot is a first foot, and wherein the elongated support channel extends between the first and second shear beam load cells.

In some embodiments, the shear beam load cell is secured to the elongated support channel by one or more retainers.

In some embodiments, the bale weighing kit further includes a processor operatively connected to the scale and configured to receive and transmit data output from the scale.

In some embodiments, the data output is a weight of a waste container of the baler, a ram of the baler, and/or a material in the waste container.

In some embodiments, the bale weighing kit further includes a user interface configured to present the data output of the scale to a user.

In some embodiments, the bale weighing kit further includes a printer configured to print the data output of the scale to a user.

In some embodiments, the baler is a vertical baler.

In some embodiments, the scale is responsive to a weight of a waste container of the baler, a ram of the baler, and a material in the waste container.

In some embodiments, the elongated support channel defines a first notch configured to receive and interlock with a second notch defined by the anchor brace.

Another aspect of the present disclosure features a bale weighing kit including: a scale configured to rest on a support surface; a platform configured to support a baler; and an anchor brace including an anchor plate, the anchor plate configured to constrain movement of the platform with respect to the support surface, wherein the anchor plate defines a slot recess on an innermost corner relative to the center of the platform, the slot recess configured to receive a foot of the scale.

In some embodiments, the platform is configured to be removably coupled with a structural feature of a base of the baler.

In some embodiments, the structural feature is a laterally-extending flange of the base of the baler.

In some embodiments, the anchor brace is configured to be coupled with the platform.

In some embodiments, the anchor brace has a pair of angled walls and a brace cap opposing the anchor plate.

In some embodiments, wherein a corner of the platform is configured to receive the pair of angled walls of the anchor brace, and wherein the anchor plate is configured to rest on the support surface.

In some embodiments, the slot recess is U-shaped and has a diameter that is configured to conform to at least a portion of a foot of the scale.

In some embodiments, the scale includes a shear beam load cell having a first end extending under and secured to an inner surface of the platform, and a second end supported on a foot resting on the support surface.

In some embodiments, the scale further includes a second shear beam load cell extending under and secured to an inner surface of the platform, the second shear beam load cell including a third end supported on a second foot resting on the support surface, wherein the shear beam load cell is a first shear beam load cell, the foot is a first foot.

In some embodiments, the shear beam load cell is secured to the inner surface of the platform by one or more retainers.

In some embodiments, the bale weighing kit further includes a processor operatively connected to the scale and configured to receive and transmit data output from the scale.

In some embodiments, the data output is a weight of a waste container of the baler, a ram of the baler, and/or a material in the waste container.

In some embodiments, the bale weighing kit further includes a user interface configured to present the data output of the scale to a user.

In some embodiments, the bale weighing kit further includes a printer configured to print the data output of the scale to a user.

In some embodiments, the baler is a vertical baler.

In some embodiments, the anchor plate is configured to be secured to the support surface at one or more mounting points.

In some embodiments, the platform includes a surface plate configured to support the baler.

Yet another aspect of the present disclosure features a bale weighing kit including: a scale configured to rest on a support surface; a platform configured to support a baler; and an anchor brace including a pair of angled walls, the pair of angled walls configured to constrain movement of the platform with respect to the support surface, wherein the pair of angled walls are integrally connected to and extend vertically upward from a surface of the anchor brace.

In still yet another aspect, the present disclosure features a baling system, including: a baler including: a baler base; a waste container adapted to hold a quantity of material to be baled; a compression ram positioned to compress material within the waste container to form a bale; and a bale weighing kit including: a scale; an elongated support channel configured to couple with the scale and support a baler; and an anchor brace configured to couple with the elongated support channel and laterally constrain movement of the elongated support channel with respect to a ground support surface, the anchor brace including an anchor plate with a surface configured to receive and support a portion of the scale.

In some embodiments, the elongated support channel is configured to be removably coupled with a structural feature of a base of the baler.

In some embodiments, the structural feature is a laterally-extending flange of the base of the baler.

In some embodiments, the elongated support channel defines a slot configured to align with a hole defined by a base of the baler.

In some embodiments, the elongated support channel is configured to be coupled with the anchor brace in a parallel direction.

In some embodiments, the anchor brace has a pair of opposing, lateral walls and a capture plate opposing the anchor plate, the anchor plate configured to rest on the ground support surface.

In some embodiments, a lateral wall of the pair of opposing, lateral walls define a notch.

In some embodiments, the anchor plate extends longitudinally under the scale, and a foot of the scale is configured to rest on the anchor plate.

In some embodiments, the anchor plate is configured to be secured to the ground support surface at one or more mounting points.

In some embodiments, the scale includes a shear beam load cell having a first end extending over and secured to the elongated support channel, and a second end supported on a foot resting on the ground support surface.

In some embodiments, the scale further includes a second shear beam load cell extending over and secured to the elongated support channel, the second shear beam load cell including a third end supported on a second foot resting on the ground support surface, wherein the shear beam load cell is a first shear beam load cell, the foot is a first foot, and wherein the elongated support channel extends between the first and second shear beam load cells.

In some embodiments, the shear beam load cell is secured to the elongated support channel by one or more retainers.

In some embodiments, the baling system further includes a processor operatively connected to the scale and configured to receive and transmit data output from the scale.

In some embodiments, the data output is a weight of the waste container, a ram, and/or the material in the waste container.

In some embodiments, the baling system further includes a user interface configured to present the data output of the scale to a user.

In some embodiments, the baling system further includes a printer configured to print the data output of the scale to a user.

In some embodiments, the baler is a vertical baler.

In some embodiments, the scale is responsive to a weight of a waste container of the baler, a ram of the baler, and a material in the waste container.

In some embodiments, the elongated support channel defines a first notch configured to receive and interlock with a second notch defined by the anchor brace.

Still yet another aspect of the present disclosure features a baling system, including: a baler including: a baler base; a waste container adapted to hold a quantity of material to be baled; a compression ram positioned to compress material within the waste container to form a bale; and a bale weighing kit including: a scale configured to rest on a support surface; a platform configured to support a baler; and an anchor brace including an anchor plate, the anchor plate configured to constrain movement of the platform with respect to the support surface, wherein the anchor plate defines a slot recess on an innermost corner relative to the center of the platform, the slot recess configured to receive a foot of the scale.

In some embodiments, the platform is configured to be removably coupled with a structural feature of a base of the baler.

In some embodiments, the structural feature is a laterally-extending flange of the base of the baler.

In some embodiments, the anchor brace is configured to be coupled with the platform.

In some embodiments, the anchor brace has a pair of angled walls and a brace cap opposing the anchor plate.

In some embodiments, a corner of the platform is configured to receive the pair of angled walls of the anchor brace, and wherein the anchor plate is configured to rest on the support surface.

In some embodiments, the slot recess is U-shaped and has a diameter that is configured to conform to at least a portion of a foot of the scale.

In some embodiments, the scale includes a shear beam load cell having a first end extending under and secured to an inner surface of the platform, and a second end supported on a foot resting on the support surface.

In some embodiments, the scale further comprises a second shear beam load cell extending under and secured to an inner surface of the platform, the second shear beam load cell including a third end supported on a second foot resting on the support surface, wherein the shear beam load cell is a first shear beam load cell, the foot is a first foot.

In some embodiments, the shear beam load cell is secured to the inner surface of the platform by one or more retainers.

In some embodiments, the baling system further includes a processor operatively connected to the scale and configured to receive and transmit data output from the scale.

In some embodiments, the data output is a weight of the waste container, a ram, and/or the material in the waste container.

In some embodiments, the baling system further includes a user interface configured to present the data output of the scale to a user.

In some embodiments, the baling system further includes a printer configured to print the data output of the scale to a user.

In some embodiments, the baler is a vertical baler.

In some embodiments, the anchor plate is configured to be secured to the support surface at one or more mounting points.

In some embodiments, the platform includes a surface plate configured to support the baler.

In still yet another aspect, the present disclosure features a baling system including: a baler including: a baler base; a waste container adapted to hold a quantity of material to be baled; a compression ram positioned to compress material within the waste container to form a bale; and a bale weighing kit including: a scale configured to rest on a support surface; a platform configured to support a baler; and an anchor brace including a pair of angled walls, the pair of angled walls configured to constrain movement of the platform with respect to the support surface, wherein the pair of angled walls are integrally connected to and extend vertically upward from a surface of the anchor brace.

Some embodiments of the systems and devices described below may provide one or more of the following advantages.

Some embodiments described below may feature a weighing kit that may be easily installed and/or coupled to a baler. For example, an existing baler may be easily retrofitted with the weighing kits disclosed herein. In some embodiments, a weighing kit described below may include a support channel adapted to couple with and support a structural feature (e.g., a flange) the baler. In addition, the weighing kit can further include an anchor brace configured to couple with the support channel and further configured to support the scale. These features, and other features described throughout this disclosure, may simplify installation of the weighing kit on existing balers. For instance, in some embodiments, installation of the weighing kit can be performed without recalibrating the scale, such as by securing the baler on the support channel, securing the scale to the support channel, and securing the anchor brace to the support channel and a supporting surface (e.g., a ground surface).

Additionally, in some embodiments, the anchor brace may prevent lateral loading of the scale (e.g., a load cell) that may damage the scale if the baler is bumped, such as by a forklift.

Additionally, in some embodiments, the weighing kits described below may include a platform that is configured to receive the baler and an anchor brace configured to support the platform. These features, and other features described throughout this disclosure, may simplify installation of the weighing kit on existing balers. For instance, in some embodiments, installation of the weighing kit can be performed without recalibrating the scale, such as by securing the baler on the platform, securing the scale to the platform, and securing the anchor brace to the platform and a supporting surface (e.g., a ground surface).

Additionally, various aspects of the embodiments described below provide weighing kits including an anchor plate that can provide support and stability to the scale(s) of the weighing kit. The added support and stability may mitigate or completely prevent lateral movement or sliding of the scale(s), thereby improving the weight measurement accuracy and overall performance of the weighing system.

Additionally, the embodiments described below provide weighing kits including configurations that advantageously provide an operator easy access to the scale(s) of the weighing kit, thereby facilitating installation and/or removal of a scale, if necessary (e.g., if a scale fails and requires replacement).

The details of one or more embodiments of the invention are set forth in the accompanying drawings and the description below. Other features, objects, and advantages of the invention will be apparent from the description, the drawings, and the claims.

### DESCRIPTION OF DRAWINGS

FIG. 1 is a perspective view of a first baling system including a baler and a first weighing kit.

FIG. 2 is an enlarged, perspective view of the first weighing kit of FIG. 1.

FIG. 3 is a perspective view of a support channel of the first weighing kit of FIG. 1.

FIG. 3 is an enlarged, perspective view of a scale of the first weighing kit of FIG. 1.

FIGS. 4A, 4B, and 4C are enlarged perspective, side, and front views, respectively, of a scale of the first weighing kit of FIG. 1.

FIG. 5 is a perspective view of a second baling system including a baler and a second weighing kit.

FIG. 6 is an enlarged, perspective view of the second weighing kit of FIG. 5.

FIGS. 7A and 7B are an enlarged perspective and side views, respectively, of an anchor brace of the second weighing kit of FIG. 5.

FIG. 8 is a partial bottom view of a platform and scales of the second weighing kit of FIG. 5.

Like reference symbols in the various drawings indicate like elements.

### DETAILED DESCRIPTION

Embodiments described below include baling systems featuring a compactor device (e.g., a vertical baler) including a scale and an anchor. In some embodiments, the scale is part of a weighing system that is configured to measure a weight of a waste container of the baler, a compression ram, and/or material in the waste container. In some embodiments, the weighing system is part of a kit used to retrofit an existing baler.

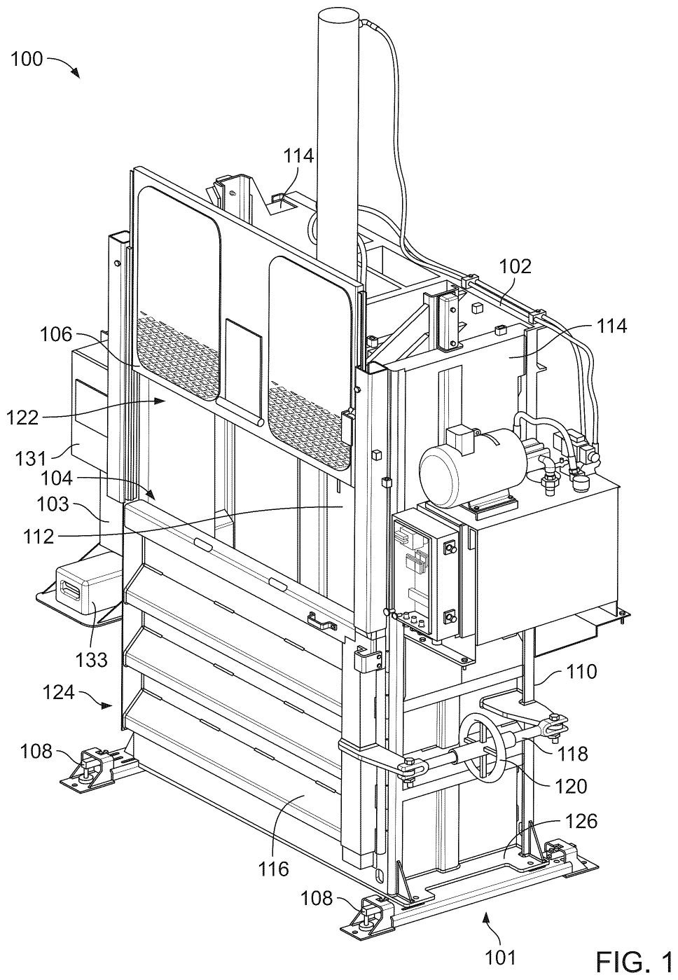

FIG. 1 is a perspective view of an exemplary baling system 100 including a baler 102 (e.g., a vertical baler) and a weighing kit 101. The baler 102 includes a compression ram 106 that is configured to compact material, such as recyclable material, refuse, or the like. The baler 102 includes a frame 110 having a back wall 112 extending orthogonally between a pair of opposing side walls 114. The baler 102 further includes a bale door 116 having a first edge that is pivotably coupled to the frame 110 via a hinge and a second edge that is hingedly coupled to the frame 110 by a turnbuckle latch 118. A user can open and close the turnbuckle latch 118, and consequently unlock and lock the bale door 116, by rotating a wheel 120. The back wall 112, opposing side walls 114, and the bale door 116 (when in a closed position) together define a waste container 104 or compaction chamber. The waste container 104 is adapted to hold a quantity of material to be baled. The compression ram 106 is positioned within the baler 102 to compress material within the waste container 104 to form a bale. For example, the compression ram 106 is configured for vertical travel, between a first end 122 and a second end 124 of the baler 102, within the waste container 104, to compact material contained within the waste container 104.

The baler 102 includes a baler base 126 that is configured to support the operating components of the baler 102. In this example, the baler base 126 extends along the width of each side wall 114. The baler base 126 includes a laterally-extending flange 128 protruding from each corner of the baler base 126. The flange 128 is substantially rectangular in shape. The flanges described herein are merely exemplary and not intended to limit the present disclosure in any way. Other embodiments with flanges or support surfaces of different shapes (e.g., circular or polygonal), sizes, locations, and configurations are contemplated within the scope of

In this example, the baler base 126 and the flange 128 are made of one or more materials that have mechanical properties such as hardness and toughness that allow the baler base 126 and flange 128 to withstand friction, abrasion, absorb energy without fracturing and/or rupturing, and support the baler 102. Exemplary materials from which the baler base 126 and flange 128 are typically made include steel (e.g., stainless steel, cold-rolled steel, or the like).

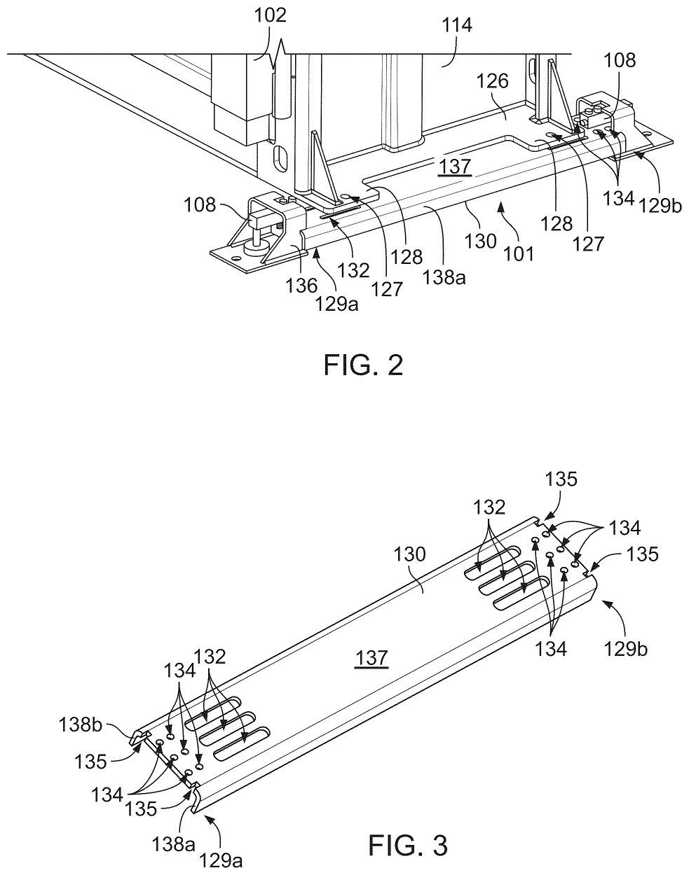

FIG. 2 is an enlarged view of a portion of the weighing kit 101 installed on the baler 102. The weighing kit 101 includes two support channels 130, four anchor braces 136, and four scales 108.

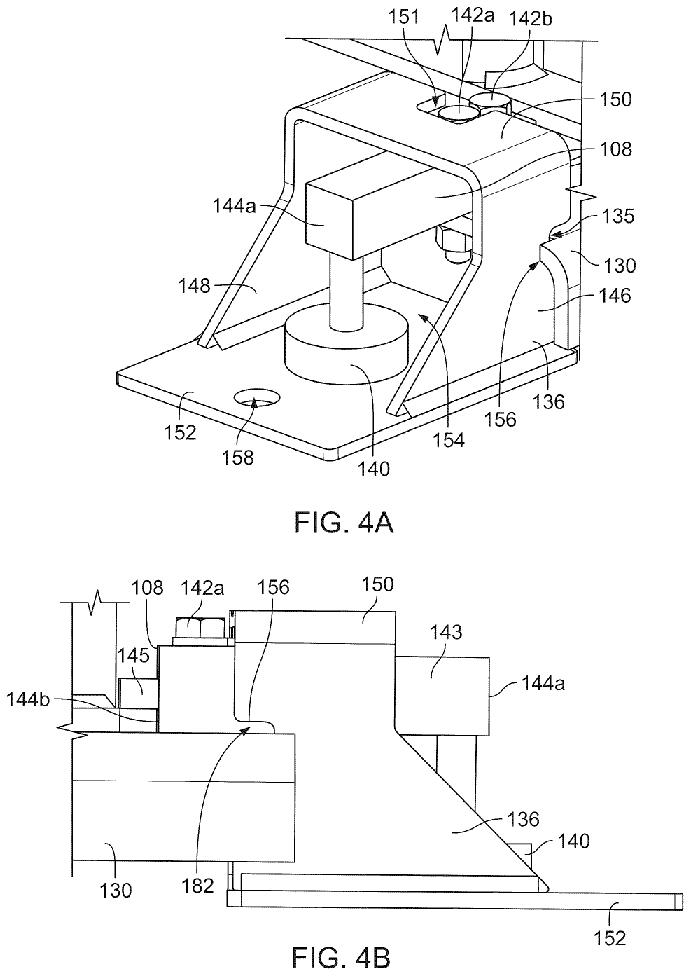

Each support channel 130 extends from a first end 129a to a second end 129b, along the width of the baler's side wall 114. The support channel 130 has a planar surface 137 configured to support a structural feature (e.g., a flange 128) of the base 126 of the baler 102, along the width of the side wall 114. The support channel 130 is configured to be removably coupled with a structural feature (e.g., a flange 128) of the base 126 of the baler 102. The baler's flange 128 defines a hole 127 that is configured to receive a retainer (e.g., a suitable bolt or other fastener) to secure the flange 128 onto the support channel 130. The hole 127 is a through hole. The support channel 130 further includes a pair of opposing walls 138a, 138b (see FIG. 3) that are integrally connected with and extend downwardly from the planar surface 137. Thus, the support channel 130 can have a shape that has a partial square cross-section, a partial rectangular cross-section, and/or a partial, inverted U-shaped cross-section.

Referring to FIG. 3, the planar surface 137 of the support channel 130 defines six holes 134 symmetrically arranged in an array at each of the first and second ends 129a, 129b. Each array has two rows and three columns, with the columns distributed along the width of the support channel 130. The holes 134 are through holes, each configured to receive a retainer that secures a scale 108 to the support channel 130.

The support channel 130 further defines three elongated slots 132 near each of the first and second ends 129a, 129b. The slots 132 are elongated in the direction of the length of the support channel 130. Each of the elongated slots 132 is aligned with a respective column of the array of holes 134. Each of the elongated slots 132 is located medially in the length direction of the support channel 130 relative to the holes 134 and the first and second ends 129a, 129b. And each of the elongated slots 132 receive a retainer to secure the baler's flange 128 onto the support channel 130.

The multiple holes 134 and slots 132 may advantageously provide flexibility in positioning and securing the base 126 of the baler 102 and the scales 108 to the support channel 130 during installation of the weighing kit 101. In other words, less than all of the holes and slots may be used during installation. There are redundant holes and slots so that the installer(s) can select the appropriate subset that achieves sufficient alignment for a given preexisting baler and installation environment.

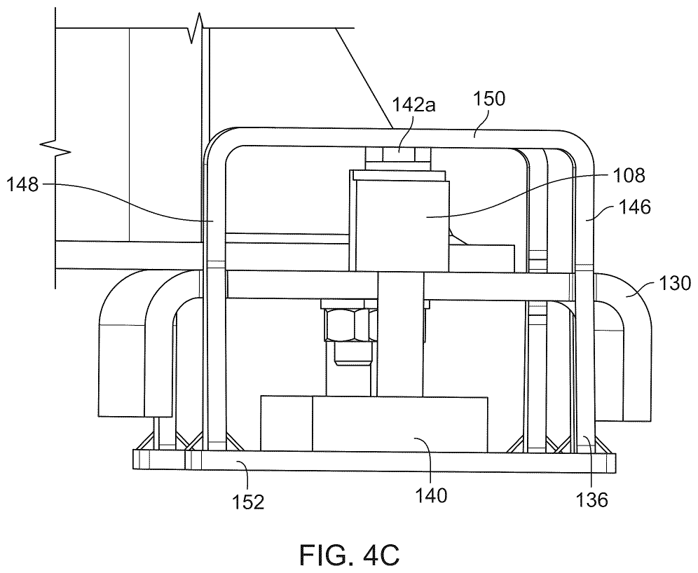

Referring to FIGS. 4A, 4B, and 4C, the weighing kit 101 includes four anchor braces 136. Each anchor brace 136 is configured to be positioned proximate each of the four corners of the base 126 of the baler 102. Each anchor brace 136 is configured to configured to constrain movement of the support channel 130 to which it is secured.

Each anchor brace 136 includes a pair of opposing lateral walls 146, 148 that are coupled (e.g., integrally coupled) to and extend upwardly from a surface of an anchor plate 152. The pair of opposing lateral walls 146, 148 are connected by a capture plate 150. The opposing, upright lateral walls 146, 148, anchor plate 152, and capture plate 150 together define an interior space 154. The anchor plate 152 is adapted to rest on a support surface (e.g., a ground surface). In this example, the anchor plate 152 is configured to be secured to the support surface using one or more retainers (e.g., any suitable bolt, nut, and/or screw fastener) in conjunction with through-hole 158. One or both of the opposing lateral walls 146, 148 defines a notch 156 that is configured to receive the support channel 130. Specifically, the notch 156 is defined by a distal edge of one or both of the opposing lateral walls 146, 148.

As shown in FIG. 3, the support channel 130 also defines a notch 135 configured to receive and interlock with the notch 156 of the anchor brace 136. In this example, the support channel 130 defines two notches 135 at each of its first and second ends 129a, 129b; four notches 135 in total. Each notch 135 is defined by an edge of the support channel's planar surface 137. Thus, the support channel 130 is configured to be coupled with the anchor brace 136 by engaging and interlocking the notch 156 of the anchor brace 136 with the notch 135 of the support channel 130, as shown in FIG. 4A. In this example, the notches 156, 135 interlock at a vertical location that is about half of the height of one or both of the opposing lateral walls 146, 148. The notches 135, which are defined by the support channel 130, constrain a lateral movement of the anchor brace 136 relative to the support channel 130. As shown in FIG. 4B, a gap 182 exists between the notch 156 and the surface of the support channel 130. Thus, the notches 156, which are defined by the lateral walls 146, 148 of the anchor brace 136, allow a limited amount of vertical movement of the support channel 130 relative to the anchor brace 136. This limited amount of vertical movement of the support channel 130 relative to the anchor brace 136 is determined by the height of the gap 182.

Still referring to FIGS. 4A, 4B, and 4C, the weighing kit 101 includes four scales 108. The four scales 108 are secured to the respective ends of the pair of support channels 130 and are housed by the anchor braces 136.

Each of the scales 108 is responsive to a weight of the waste container 104, the compression ram 106, the amount of force being applied by the compression ram 106, and/or material in the waste container 104. In this example, the scale 108 has a beam body 143 extending between a first end 144a and a second end 144b. The first end 144a defines two through-holes configured to receive a first retainer 142a and a second retainer 142b (e.g., any suitable bolt, nut, and/or screw fastener). The first end 144a of the beam body 143 overlaps and is secured to the support channel 130 (i.e., at a first end 129a or at a second end 129b) via first and second retainers 142a, 142b in conjunction with a selected column of the support channel's holes 134 (see FIG. 3). Specifically, the scale 108 is configured to be secured to the support channel 130 by aligning the through-holes of the scale 108 with the holes 134 defined by the support channel 130 and inserting the first and second retainers 142a, 142b through the aligned through-holes of the scale 108 and the holes 134, which can then be fastened to secure the scale 108.

During use, the first end 144a of the beam body 143 is configured to receive a load force (e.g., a weight of the waste container 104, the compression ram 106, the amount of force being applied by the compression ram 106, and/or the material in the waste container 104). The second end 144b is supported on a foot 140 that extends from the second end 144b and is configured to rest on a surface (e.g., the anchor plate 152). Each scale 108 is configured to be housed by an anchor brace 136 such that at least a portion of the beam body 143 is positioned between the pair of opposing lateral walls 146, 148, and under the capture plate 150. When in an assembled state, the anchor plate 152 extends longitudinally under the scale 108, and the foot 140 of the scale 108 is configured to further rest on the anchor plate 152. The capture plate 150 further defines a recess 151 that receives the first and second retainers 142a, 142b of the scale 108. In this example, the housing provided by the anchor brace 136 have substantial openings that provide access to the scale 108 and its first and second retainers 142a, 142b, thereby facilitating easy installation, replacement, and/or removal of the scale 108.

In some embodiments, the scale 108 is a shear beam load cell with one or more strain gauges that are positioned to measure shear in a beam-shaped cell and are connected to an appropriate electrical circuit. The strain gauges of the shear beam load cells are configured for sensing the strain caused by the stresses of shear imposed on the beam-shaped cell, thereby producing data output (e.g., readings or measurements) that is proportional to a load applied substantially perpendicular to the longitudinal direction of the beam. The shear beam load cell can measure both large and small loads, is accurate, and can be used in many different industrial weighing environments. The shear beam load cell is also low-profile, small in size, and has low sensitivity to changes in point-of-load application and to adverse side forces.

Referring back to FIG. 1, the weighing kit 101 can further include a controller 131 comprising one or more processors. The controller 131 and the one or more processors are operatively connected to the scale 108 and configured to perform certain operations. For example, the one or more processors are configured to receive and transmit data output from the scale 108. The controller 131 can be a programmable logic controllers (PLC). In some embodiments, the weighing kit 101 further includes a load cell transmitter and/or a load cell amplifier that are/is operatively connected to the scale 108 and the one or more processors. In some embodiments, the load cell transmitter and/or load cell amplifier are/is configured to convert a weak signal transmitted by the scale 108 into a standard industrial process signal that can be transmitted to and received by the controller 131 and the one or more processors. The scale 108 includes a connector 145 (e.g., one or more wires), as shown in FIG. 4B, configured to operatively connect to the controller 131, the one or more processors, and/or a power source. The data output can include the weight of the waste container 104, the compression ram 106, the amount of force being applied by the compression ram 106, and/or the material in the waste container 104.

The controller 131 is configured to record data output transmitted by the scale 108. The controller 131 further includes an interface configured to transmit the data output (e.g., weight data) to a remote location, either by wire or wirelessly. The controller 131 can include a tare function for “zeroing” a reading when the baler is empty. Alternatively or additionally, the controller 131 can record the empty baler weight as an offset to future readings. In some embodiments, the controller 131 is not operatively connected to one or more processors of the baler 102.

The one or more processors are configured to determine, based on the data output transmitted by the scale 108 to the one or more processors, a weight of the waste container 104, the compression ram 106, the amount of force being applied by the compression ram 106, and/or the material in the waste container 104. The one or more processors can be configured to determine, based on the data output transmitted by the scale 108 to the one or more processors, a weight of only the material in the waste container 104. The one or more processors are configured to determine, based on the data output received from the scale 108, that the weight of the material in the waste container 104 corresponds to a maximum bale weight. In some embodiments, the one or more processors can be configured to, based on the data output received from the scale 108, further automatically activate the compression ram 106 to begin compressing the material to form a bale in response to the determination of the maximum bale weight. The one or more processors can be configured to determine, based on the data output received from the scale 108, the weight of a bale within the waste container 104 (e.g., after bale formation but prior to bale ejection).

In some embodiments, the one or more processors are configured to, in response to determining a weight of a bale within the waste container 104, generate an indicator (e.g., on a display of the controller 131) to indicate that a bale has been generated. The indicator can be one or more of a visual alarm, an audible alarm, an indicator light, and a notification on a display coupled (wirelessly or via wire) to the one or more processors of the controller 131. In some embodiments, the one the one or more processors send one or more signals (e.g., to a display such as a remote display, a display on-site, and/or a display on the controller 131 or to a remote computer) indicating a weight of the waste container 104, the compression ram 106, the amount of force being applied by the compression ram 106, and/or the material in the waste container 104.

Still referring back to FIG. 1, the weighing kit 101 further includes a printer 133 configured to print the data output of the scale 108 to a user. The printer 133 is operatively connected to the controller 131 and to the scales 108. In some embodiments, the printer 133 is configured to print one or more labels indicating the weight measurement generated by the scales 108 (e.g., the weight of a bale). The weighing kit 101 further includes a stand 103 that can be mounted on the support channel 130 or otherwise be secured to the baler 102. The stand 103 includes at least one shelf to support the printer 133. The controller 131 can be mounted on a wall of or otherwise be supported by the stand 103. The stand 103 further includes an electric wiring channel configured to house and route the electronic wires from the scales 108 to the controller 131.

A baling system 200 may be substantially similar in construction and function in several aspects to the baling system 100 discussed above but can include an alternative weighing kit instead of the weighing kit 101. In some embodiments, the alternative weighing kit includes a platform and an anchor brace. In some embodiments, the anchor brace further includes an anchor plate that can provide support and prevent any lateral and/or longitudinal movement of the scale. In some embodiments, the platform may reduce the installation time of the weighing kit given that the baler simply needs to be positioned and secured on the platform. Such alternative configuration can provide scale stability while also facilitating installation.

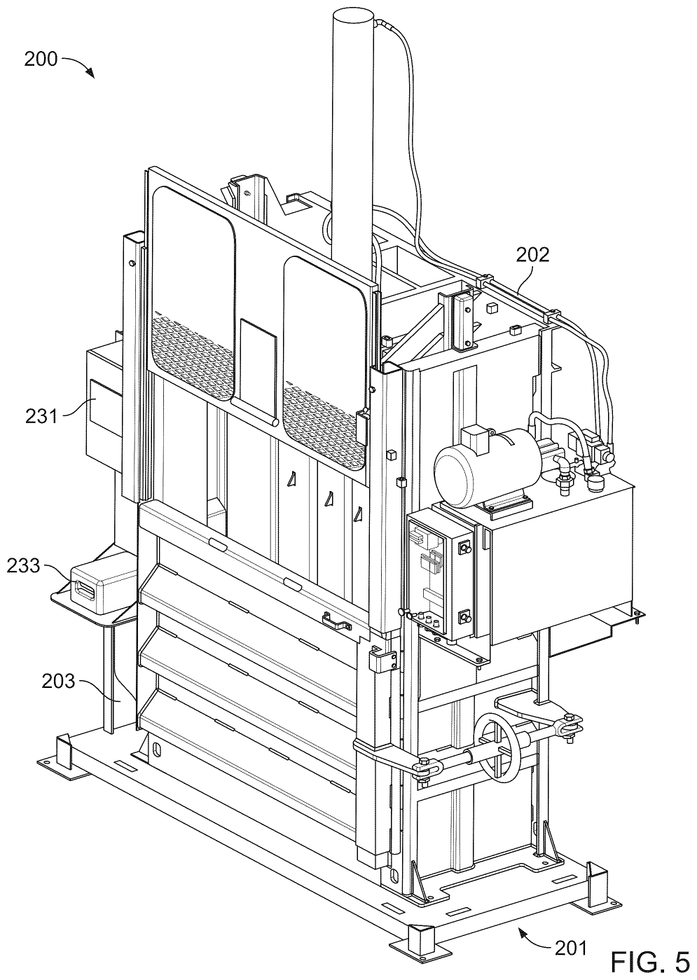

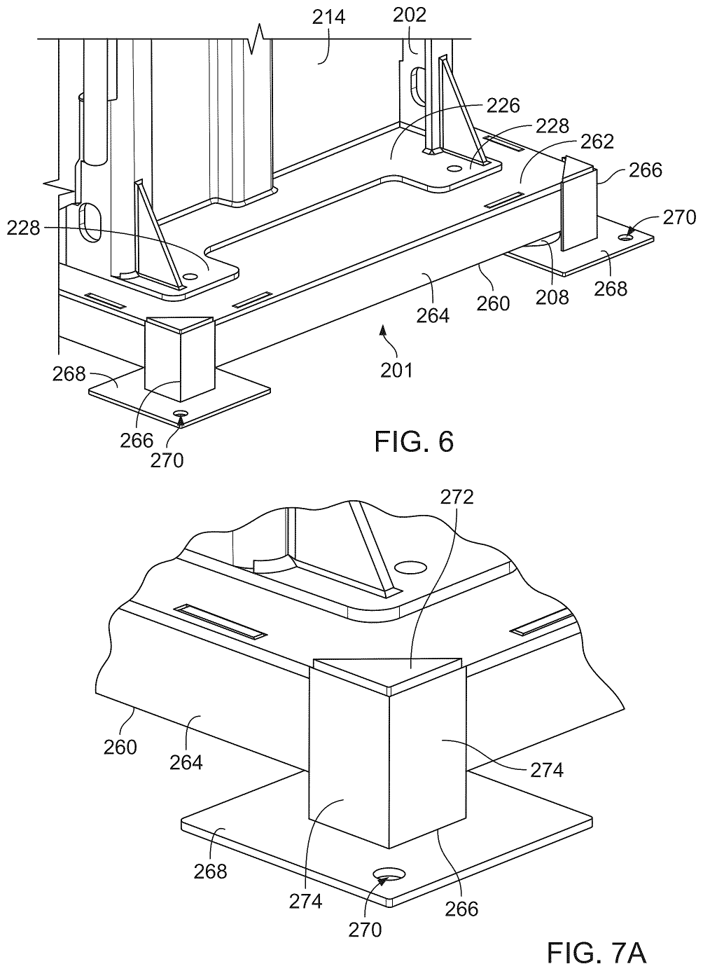

FIGS. 5-8 illustrate a baling system 200 having a weighing kit 201 and a baler 202 (e.g., a vertical baler). Referring to FIG. 6, the weighing kit 201 includes a platform 260 and four anchor braces 266. In this example, the platform 260 has a rectangular shape and includes a surface plate 262 and a base brace 264. The surface plate 262 is configured to support the bottom surface of the baler 202 including the base 226 (and its flanges 228). In this example, the baler 202 includes a pair of bases 226, each extending along the width of a side wall 214. Each base 226 includes a laterally-extending flange 228 protruding from each corner of the base 226. The flange 228 is substantially rectangular in shape. Like base 126 and flange 128 from the embodiment in FIG. 1, the baler's base 226 and the flange 228 can be made of one or more materials (e.g., stainless steel, abrasion-resistant steel, or the like) having mechanical properties (e.g., hardness and toughness) that allow the baler's base 226 and flange 228 to withstand friction, abrasion, absorb energy without fracturing and/or rupturing, and support the baler 202. The flanges 228 define holes configured to receive retainers to secure the baler 202 atop the surface plate 262 of the platform 260. As shown, the base brace 264 is integrally connected to and extends from the surface plate 262.

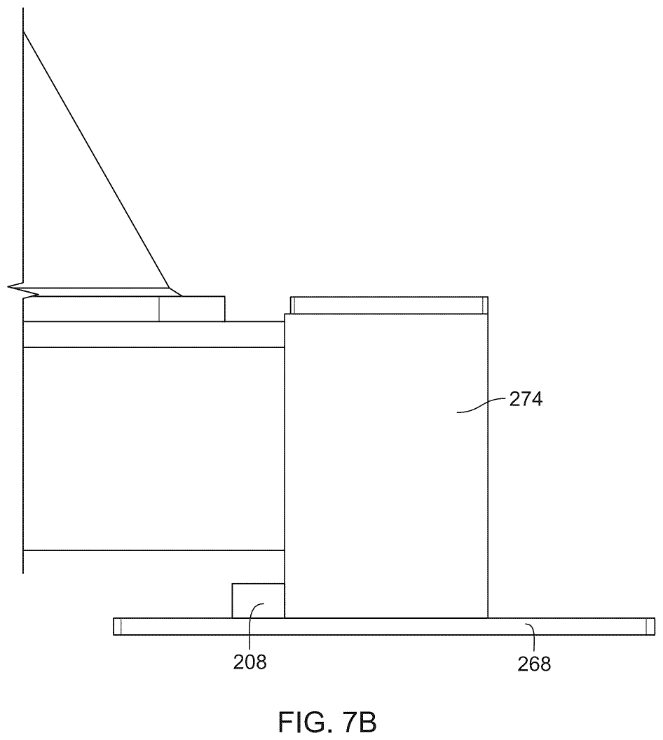

Referring to FIGS. 7A and 7B, and also shown in FIG. 6, four anchor braces 266 are coupled to the platform 260. The anchor braces 266 are adapted to constrain movement of the platform 260 with respect to a support surface (e.g., a ground surface).

Each anchor brace 266 includes an anchor plate 268 and a pair of angled walls 274. The pair of angled walls 274 contact the surfaces of the base brace 264 to constrain lateral movement of the platform 260 relative to the anchor plate 268. The anchor plate 268 defines a hole 270 configured to receive a retainer and has a planar surface that is configured to rest on a support surface (e.g., a ground surface). The anchor plate 268 is configured to be secured to the support surface at one or more mounting points by inserting a retainer through the hole 270 and fastening anchor plate 268 to the support surface (e.g., a ground surface). The distal portions of the pair of angled walls 274 are integrally connected to and extend vertically upward from the planar surface of the anchor plate 268. As shown in FIG. 7A, the walls 274 are angled relative to one another such that they form a corner structure coupled to a corner of the platform 260. The proximal edges of the pair of angled walls 274 are connected by a brace cap 272 that is opposite the anchor plate 268 and overlaps the corner of the surface plate 262. A gap exists between the brace cap 272 and the surface of the surface plate 262 such that vertical movement of the platform 160 is reduced to a limited amount.

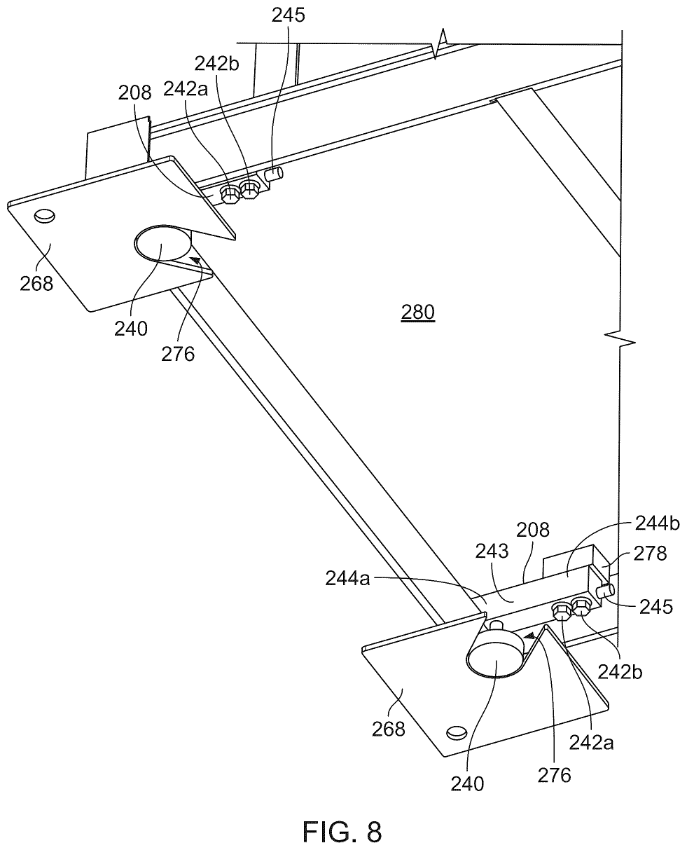

Referring to FIG. 8, the scale 208 has a beam body 243 extending between a first end 244a and a second end 244b. The beam body 243 is supported on the support surface by a foot 240. In this example, the scale 208 is positioned beneath the platform 260. The second end 244b of the beam body 243 extends under and is secured to an inner, bottom surface 280 of the platform 260. The second end 244b defines two through-holes configured to receive a first retainer 242a and a second retainer 242b (e.g., any suitable bolt, nut, and/or screw fastener). The first and second retainers 242a, 242b secure the beam body 243 to a support block 278 on the bottom surface of the platform 260.

The scales 208 may be substantially similar in construction and function in several aspects to the scales 108 discussed above. For example, in some embodiments, the scale 208 is a shear beam load cell with one or more strain gauges that are positioned to measure shear in a beam-shaped cell and are connected to an appropriate electrical circuit. The strain gauges of the shear beam load cells are configured for sensing the strain caused by the stresses of shear imposed on the beam-shaped cell, thereby producing data output (e.g., readings or measurements) that is proportional to a load applied substantially perpendicular to the longitudinal direction of the beam. The shear beam load cell can measure both large and small loads, is accurate, and can be used in many different industrial weighing environments. The shear beam load cell is also low-profile, small in size, and has low sensitivity to changes in point-of-load application and to adverse side forces. However, the load on the scales 208 is applied differently than how the load is applied to the scales 108. In the embodiment that includes the baling system 200 and the scales 208, the baling system 200, including its compression ram and/or any material in its waste container, presses or applies a force on the beam body 243 of the scale 208 through the support. In the embodiment described above that includes the baling system 100 and the scales 108, the baling system 100, including its compression ram and/or any material in its waste container, pulls or exerts a downward force on the beam body 143 of the scale 108 via the support channel 130. In other words, the weight of the baling system 100 is suspended from the beam body 143 of the scale 108, while the weight of baling system 200 is pressing on the beam body 243 of the scale 208.

Still referring to FIG. 8, the anchor plate 268 defines a slot recess 276 configured to receive a foot 240 of the scale 208. The slot recess 276 is U-shaped, with its open end at a corner of the rectangular anchor plate 268, and has a diameter that is configured to conform to at least a portion of a foot 240 of the scale 208. The function of the slot recess 276 is to position the platform 260 carrying the scale 208 relative to anchor brace 266 during installation. The four anchor plates 268 are oriented such that their respective slot recesses 276 are on the innermost corners of each the anchor plate 268 relative to the center of the platform 260 (e.g., the corner closest to the center of the platform 260).

Referring back to FIG. 5, the weighing kit 201 further includes a stand 203 that is similar in construction and function to the stand 103 but can be mounted on or coupled (e.g., welded) with the platform 260 or otherwise be secured to the baler 202. For example, the stand 203 can be mounted on or coupled with the surface plate 262 of the platform 260. The stand 203 includes at least one shelf to support the printer 233. The controller 231 can be mounted on a wall of or otherwise be supported by the stand 203. The stand 203 further includes an electric wiring channel configured to house and route the electronic wires from the scales 208 to the controller 231.

While the above-discussed baling systems 100, 200 and weighing kits 101, 201 have been described and illustrated with respect to certain dimensions, shapes, arrangements, configurations, and material formulations, in some embodiments, a baling system that is otherwise substantially similar in construction and function to baling systems 100, 200 and weighing kits 101, 201 may include one or more dimensions, shapes, arrangements, configurations, and/or materials formulations that are different from the ones discussed above. For example, while the scales 108, 208 of the illustrated examples feature load cells, other forms of electronic scales are envisioned. For example, the shear beam load beam cells of the weighing kits 101, 201 may each be replaced with a scale that includes an S-type load cell, a canister load cell, a load pin, a pancake load cell, a button load cell, a compression load cell, a tension load cell, or any combination thereof.

In another example, the weighing kits 101, 201 can further include a user interface (e.g., a display) configured to present the data output of the scales to a user. The user interface (e.g., a display) can be configured to present data output (e.g., weight data such as the weight of a bale) such that it can be seen by the operator (e.g., to help avoid overloading of the baler during the baling process). The controller can include the user interface (e.g., a display). In some embodiments, the user interface can be a display monitor of a computer of a network (e.g., located remotely in a central office). In some examples, the display can be a display screen operatively connected to the controller. In some embodiments, the display can be a display screen of a mobile device (e.g., a smartphone, a tablet, or the like) that is operatively connected to the controller.

While a number of examples have been described for illustration purposes, the foregoing description is not intended to limit the scope of the invention, which is defined by the scope of the appended claims. For example, a baling system may have more or less scales than shown, or more or less anchor points, or a different arrangement or number of flanges. There are and will be other examples and modifications within the scope of the following claims.

What is claimed is:

1. A bale weighing kit comprising:
a scale;
an elongated support channel configured to couple with the scale and support a baler; and
an anchor brace configured to couple with the elongated support channel and laterally constrain movement of the elongated support channel with respect to a ground support surface, the anchor brace comprising an anchor plate with a surface configured to receive and support a portion of the scale.

2. The bale weighing kit of claim 1, wherein the elongated support channel is configured to be removably coupled with a structural feature of a base of the baler, wherein the structural feature is a laterally-extending flange of the base of the baler.

3. The bale weighing kit of claim 1, wherein the elongated support channel defines a slot configured to align with a hole defined by a base of the baler.

4. The bale weighing kit of claim 1, wherein the elongated support channel is configured to be coupled with the anchor brace in a parallel direction.

5. The bale weighing kit of claim 1, wherein the anchor brace has a pair of opposing, lateral walls and a capture plate opposing the anchor plate, the anchor plate configured to rest on the ground support surface, wherein a lateral wall of the pair of opposing, lateral walls define a notch.

6. The bale weighing kit of claim 4, wherein the anchor plate extends longitudinally under the scale, and a foot of the scale is configured to rest on the anchor plate.

7. The bale weighing kit of claim 4, wherein the anchor plate is configured to be secured to the ground support surface at one or more mounting points.

8. The bale weighing kit of claim 1, wherein the scale comprises a shear beam load cell having a first end extending over and secured to the elongated support channel, and a second end supported on a foot resting on the ground support surface.

9. The bale weighing kit of claim 8, wherein the scale further comprises a second shear beam load cell extending over and secured to the elongated support channel, the second shear beam load cell including a third end supported on a second foot resting on the ground support surface, wherein the shear beam load cell is a first shear beam load cell, the foot is a first foot, and wherein the elongated support channel extends between the first and second shear beam load cells.

10. The bale weighing kit of claim 8, wherein the shear beam load cell is secured to the elongated support channel by one or more retainers.

11. The bale weighing kit of claim 1, further comprising a processor operatively connected to the scale and configured to receive and transmit data output from the scale.

12. The bale weighing kit of claim 11, wherein the data output is a weight of a waste container of the baler, a ram of the baler, and/or a material in the waste container.

13. The bale weighing kit of claim 11, further comprising a user interface configured to present the data output of the scale to a user.

14. The bale weighing kit of claim 11, further comprising a printer configured to print the data output of the scale to a user.

15. The bale weighing kit of claim 1, wherein the baler is a vertical baler.

16. The bale weighing kit of claim 1, wherein the scale is responsive to a weight of a waste container of the baler, a ram of the baler, and a material in the waste container.

17. The bale weighing kit of claim 1, wherein the elongated support channel defines a first notch configured to receive and interlock with a second notch defined by the anchor brace.

18. A bale weighing kit comprising:
a scale configured to rest on a support surface;
a platform configured to support a baler; and
an anchor brace comprising an anchor plate, the anchor plate configured to constrain movement of the platform with respect to the support surface,
wherein the anchor plate defines a slot recess on an innermost corner relative to the center of the platform, the slot recess configured to receive a foot of the scale.

19. A bale weighing kit comprising:
a scale configured to rest on a support surface;
a platform configured to support a baler; and
an anchor brace comprising a pair of angled walls, the pair of angled walls configured to constrain movement of the platform with respect to the support surface,
wherein the pair of angled walls are integrally connected to and extend vertically upward from a surface of the anchor brace.

20. A baling system, comprising:
a baler comprising:
a baler base;
a waste container adapted to hold a quantity of material to be baled;
a compression ram positioned to compress material within the waste container to form a bale; and
a bale weighing kit comprising:
a scale;
an elongated support channel configured to couple with the scale and support a baler; and
an anchor brace configured to couple with the elongated support channel and laterally constrain movement of the elongated support channel with respect to a ground support surface, the anchor brace comprising an anchor plate with a surface configured to receive and support a portion of the scale.
